(19) United States
(12) Patent Application Publication
(10) Pub. No.: US 2011/0029341 A1
(43) Pub. Date: Feb. 3, 2011

(54) SYSTEM AND METHOD FOR GATHERING AND UTILIZING BUILDING ENERGY INFORMATION

(75) Inventors: Kenneth Muse, Avondale Estates, GA (US); Sean McCloskey, Alpharetta, GA (US)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: ECOINSIGHT, INC., Atlanta, GA (US)

(21) Appl. No.: 12/847,837

(22) Filed: Jul. 30, 2010

Related U.S. Application Data
(60) Provisional application No. 61/230,257, filed on Jul. 31, 2009.

(51) Int. Cl. G06Q 10/00; G06F 15/16; G06F 3/00; G06F 3/02

(52) U.S. Cl. 705/7; 709/203; 709/223; 715/700; 345/168

(57) ABSTRACT

A system and method for gathering and utilizing building energy information. A central management server communicates through a wide area network to one or more client devices. The central management server maintains a set of measured or calculated audit data for a plurality of buildings and facilities, with icons and text representing auditing and analysis tasks that may be performed in the process of auditing the structures and related energy-consuming equipment and shell characteristics. The client device communicates with the central management server through the wide area network and is operative to receive user input and display user data. The client device is operative to receive a login request from a user and in response thereto, transmit a message containing the user specified and calculated information, including any related images.

### CROSS REFERENCE TO RELATED APPLICATION

This application claims the benefits of and priority to U.S. Provisional Application No. 61/230,257, filed Jul. 31, 2009, which is incorporated herein by reference, under 35 U.S.C. §119(e).

### TECHNICAL FIELD

The invention relates generally to the field of network-based services and, more particularly, to an online system that gathers, manages, and organizes measured and predicted energy information for a plurality of different buildings.

### BACKGROUND

With the increased focus on reducing energy consumption (demand) and the corresponding impact on the environment, it has become increasingly important for companies to understand the energy patterns of individual buildings and how this contributes to both green house gas emissions and corporate expenses. By understanding the components of a building and how those components interact, it is possible to determine which components can be replaced or modified in order to reduce energy demand, decrease emissions, and lower operating expenses.

The process of cataloging the components of the building is generally handled by energy audit specialists or architects. This inventory process generally involves the visual inspection of the building and its contents, understanding the usage schedules, analyzing any CAD or architectural diagrams, and determining the causes of the energy demand; the goal of this “walkthrough audit” is to attempt to identify items which can be replaced, upgrade, or modified for little or no cost. This process is generally requires familiarity with the energy audit process developed by ASHRAE (American Society of Heating, Refrigerating and Air-Conditioning Engineers) and any additional standards that might exist for that location.

This procedure results in the collection of large amounts of data related to the specific building and its characteristics. It is not uncommon for such documentation to be range in size from 20 pages to 300 pages for a single building structure. Unfortunately, this presentation of the information has limited usefulness due to the amount of information present and its organization. These details lose validity as the building and its contents are changed or upgraded over time. The information becomes even less useful in situations where components may be shared among several buildings. This is very common situation for educational campuses which may share energy facilities such as heating, cooling, or power generation among several buildings. These situations tend to make it very difficult to determine the best manner for improving the energy efficiency of a building due to the impact any such change may have on other buildings or structures that share the same resources.

Further, in order to best determine the energy characteristics of a proposed change, a series of computer based simulations are generally required to be run in order to understand the impact of the change. Several standard simulation programs and algorithms have emerged for this task, such as DOE-2, Energy Plus, and BLAST. There have been attempts to utilize this process during the design of a building by incorporating this into the CAD software. This mechanism does not work well for existing buildings due to the fact that it assumes no variation from the proposed equipment, schedules, and usage. Invariably, all buildings frequently experience such changes throughout the usable lifetime of the structure. These changes can significantly alter the energy usage patterns or create stresses on the building which may cause the building to perform differently that the models might suggest. Without a means of cataloging the changes and comparing the actual behaviors against the expected behaviors, such a system cannot be corrected to provide a more accurate assessment of the results.

To make matters more difficult, the formulas require specific information about characteristics of the system that are not generally and widely available, such as efficiency factors and regional pricing. This tends to push companies and individuals to re-use known systems. Additional characteristics, such as average maintenance costs and timing, mean time before failure, and system reliability are not included in such simulations. In practice, this means that systems which are modeled may significantly underperform compared to the simulation, or such systems may require early replacement or substantial maintenance in order for it to achieve the simulated results. These systems rely on a degree of experience and knowledge of specific systems that the firm performing the simulation has come to rely upon in order to get meaningful results. A person with limited background in this field will generally find it impossible to create simulations that provide value to the building owner or operator.

The current simulation systems further require that for each new change, a new simulation must be configured. While common files may be created to be shared among the various simulations, the simulations are still individual simulations. The ability to create new versions of a simulation is unavailable. That it, one cannot simply create a new revision of a simulation based on the original to investigate additional ways to provide energy savings. For example, the existing systems provide no means to analyze a change such as the upgrade of a component of the ventilation system against the upgrade of that component combined with additional replacements, such as new lighting or improved air handling. Once such changes are decided upon, there is further no way to convert such simulations into a practical statement of work and bill of materials. Such systems are detached from any purchasing system, so it tends to require substantial additional work to convert the simulated configuration into a package or report which can be acted upon and no way to organize or associate changes that have been made over time. This means that additional work will likely be required to re-audit the building or buildings in the future to perform any additional work. In practice, this is an especially common problem for new and existing buildings due to the need to perform substitutions of products during construction or replacement. These replacements may introduce unexpected deviations from the simulated results. With no manner to quickly re-evaluate a simulation with these changes, assumptions may be made which have a negative net impact on the results. Components may be selected which have a lower initial cost but are less efficient, not eligible under certain standards, or which are non-compliant with local building codes.

The entire problem is made more complex due to the fact that the items that might have the largest energy usage impact in a simulation may also have both the largest cost and the longest return on investment (ROI). Simply put, while a replacement or upgrade may make sense in a simulation, it may not make sense financially due to the fact that implementing the change may it result in higher expenses for the company that maintains or owns the building. This problem is compounded when the purpose of the changes is to meet requirements for a sale of the property. In this case, the persons responsible for the change and its related expenses are not the direct beneficiaries of the change. In such cases, the changes can provide a negative return on the investment. The inability to combine the analysis of a building with reports that can be tied to financial expectations and the lack of support for comparing the values that are predicted against historical performance limits the ability for the industry to make decisions which provide long-term financial benefit.

With the rise of systems for determining the “greenness” of a building (such as LEED, Energy Star, and the Green Building Initiative), it is very common for decisions to be based on attempts to gather points towards a certification. While the goal of such programs is to promote efficient energy usage, this focus on the certification can lead to decisions being made that have a negative financial impact on the building. Similar to the problems described with simulations, it is possible that a change that works for the certification might be responsible for causing changes that decrease the energy efficiency or which increase expenses. As a result of this discrepancy, it is not unusual that a report on the performance of LEED certified buildings showed that 21% of the buildings surveyed had performance that was worse than a similar building constructed simply to meet the basic building codes. In some cases, these buildings were 50% or more inefficient than buildings constructed to simply meet the current Building Code. Critics of the program have analyzed the same information and determined that the problem may be worse; one such claim indicates that on average buildings which are constructed to meet LEED guidelines are 29% less efficient than the average U.S. building. If energy costs continue to grow—for example, an analysis of pending legislation related to green house gas emissions predicts energy costs may increase 8%-20% over the next 10 years if the legislation is passed—these differences could become much larger. Decisions are made on available information. Without a way of analyzing the decision points, monitoring the actual results, and comparing the predicted results to the actual results, the current system tends to lead to decisions being made based on either arbitrary points or perceived short-term gains. With the current simulation applications and point-based certification systems being based on the assumption of a constant energy cost, the ability to predict longer term expenses becomes significantly more difficult.

Finally, it is important to examine the situations that arise when a portfolio of multiple facilities is taken into consideration. An increasingly common situation is the single-ownership or single-management of several facilities. Some examples of this situation are government or military facilities, educational campuses, or “chain” businesses. In these cases, more difficult evaluation is required. Currently, this is performed per building to maximize the efficiency of each building. Shared facilities may be left unmodified because of the difficulty in examining the resulting effects on multiple buildings. For example, it may be considered a simpler task to evaluate and replace lighting within a building instead of replacing shared boiler or HVAC systems due to the fact that any changes to centralized systems will have an effect across multiple, dependent buildings. This makes it substantially more difficult to simply consider a net change within a group of buildings as a goal; instead, each building must be individually improved with a goal of hoping that it creates a net change across a portfolio. Instead of pursuing a reduction in emissions or energy usage across a group of buildings, each building must be individually examined and pursued. This may lead to simpler solutions such as purchasing utilities, materials, or services under a bulk agreement being overlooked.

Therefore, there is an apparent need for an improved method of gathering and utilizing building energy information in a manner that gives all parties involved a way to compare potential changes and the impacts of such changes to one or more buildings in a portfolio and comparing and evaluating the financial impact, historical results, and predicted expectations to determine the optimal set of changes. This improved method needs to support a way of creating an organized strategy and bill of materials for implementing these changes, a simplified way of identifying potential changes and the financial results, and a method of comparing predicted results to achieved results to allow involved parties to identify causal agents for any deviations.

### SUMMARY OF THE INVENTION

The present invention meets the needs described above in a server that provides an efficient, centralized, and web-enabled way to manage the gathering and utilization of energy related information for a plurality of buildings. This information on a plurality of buildings and the characteristics of their energy usage can be utilized to examine the energy demands, evaluate “what-if” scenarios to determine more efficient energy usage, compare and create revisions of such scenarios for a building or plurality of buildings, and to compare predicted results to actual results as further information is gathered over time.

The system provides a centralized repository of information about a plurality of buildings that end-users may be inspecting or managing. Consequently, an auditor may organize and share this information may through a single interface. An auditor will have a consistent methodology for gathering information about the building and preparing it for creating energy usage scenarios. Rather than require a specialist in the field to guide the audit process, this invention enables less-skilled individuals to perform a complete walkthrough energy audit and systems inventory. Required and optional fields are identified and enforced by the invention to reduce duplicate data entry and potential errors or omissions. In addition, a user may grant permissions and delegate responsibilities to other individuals for specific parts of the audit process.

The structure of the data permits the storage of changes to the building. These changes may be proposed changes that are being analyzed or actual changes that have been implemented or are in the process of being implemented. Depending on the goals set by a project administrator, an auditor may be guided to examine specific changes that the invention has identified as having strategic value. This strategic value could be related to topics such as energy demand, forecasted future maintenance or energy costs, standards compliance, and emissions.

The data gathered can be related to one or more buildings. To simplify the analysis process, a catalog of the characteristics of known components is available to allow characteristics such as performance, energy factors, and maintenance/reliability estimates to be automatically associated with the component being analyzed. This significantly reduces the need for a specialist to identify and enter the values required for an energy simulation. Information which is not available in the catalog can be augmented with information from manufacturers, suppliers, or any user of the system. This allows the system to provide additional component or building information based on similar information previously gathered or new information being provided. In addition, information such as the age of the building or component can allow certain assumptions to be included based on regional buildings codes or standards that may have been enforced at the time the building was constructed or the component was installed in the building. Because an auditor can catalog a building in a consistent manner, it can be re-used and reevaluated as required. Relationships to other buildings in the portfolio can similarly be cataloged.

An energy analysis simulation can be performed against the scenario and can include additional components such as energy and emissions forecasts, maintenance costs and predictions, productivity predictions, material and labor cost assumptions, historical results, compliance, standards, and goals. The results of the simulation can be used to determine expected short-term and long-term costs and impacts. These results can be compared against goals or other scenarios. The resulting information can be cataloged and stored for use in financial models.

Cataloged changes may be analyzed and additional revisions and scenarios created to explore additional possibilities and the expected results of a change or group of changes. Alternative scenarios may be created for comparison against the baseline performance or against other proposed scenarios to allow a reviewer or financial officer to determine the most effective course of action. A selected scenario can then be used by a reviewer to create an execution plan and bill of materials to implement the changes requested. When such changes are implemented, each can be associated with the current energy usage data and patterns to understand the net effect to the building or group of buildings. This allows a plurality of buildings to be analyzed for improvement against one or more goals and a concrete plan of action to be created to implement these goals. The historical outcome of the changes can then be analyzed to allow a reviewer to understand the true impact of the decisions and act on that information accordingly. The scenarios can be analyzed against financial variables such as projected energy forecasts, projected utility based emissions, expected taxes or incentives, expected discount rates, or expected costs of goods or materials. The financial metrics can then be used for setting further corporate goals or for attempting to qualify for or obtain targets such as financing, grants, rebates, and/or compliance verification.

Rather than focusing on a single individual performing all of the various tasks, teams of auditors, reviewers, suppliers, manufacturers, architects, builders and additional persons that might be involved in the project can be created and assigned permissions within the system. In order to facilitate more accurate data entry and tighter coordination between members of these teams, collaborative features such as email, web chat, calendar, project management, video conferencing, screen sharing, programmatic interfaces (APIs), workflows, knowledge management, and document management are provided. This allows the teams of auditors and reviewers to interact in real time to more reliably and accurately manage the information or create scenarios. The results of this collaboration and any generated or existing filings, reports, or documentation can be associated to the project or building to allow for information re-use and historical tracking. Additionally, the use of these tools can be combined with workflow to enable processes to be enforced or to enable structured sharing or reporting of documents or information with team members or external entities that might have relationships with the teams.

By optionally allowing these teams access to a community of other teams performing similar work, knowledge can be shared between teams and the quality of information refined. In addition, the system can analyze the data across multiple teams to generate newer and more accurate information. As an example, regional or local pricing information which may normally be updated annually can be updated more frequently by the system as it compares its expected costs to the averages costs entered by users within a region or locality. The system can analyze and refine its data using externally provided data and through analysis of community-provided data. This constant refinement of information and data can allow the system to quickly adapt to rapid changes in the environment that can occur due to changes in resource availability, regional fluctuations, or inaccuracy in assumptions or externally acquired or provided data.

Generally speaking, the invention manages the energy information for a plurality of buildings and allows for analyzing and reporting using that information. A central computer system maintains information for static or pre-calculated information such as utility cost and emissions forecasts, equipment details, building codes, standards, localized tax and incentives information, compliance, suppliers, cost of materials and labor, and common weather information. The central computer system receives additional data from a computer network, typically the Internet. This information is stored and organized in a system database. Based on provided information, the system can infer relationships to additional data such as the location of resources and suppliers near the building, the local utility providers, related tax incentives or programs, compliance requirements, and current or historical weather conditions. Additional relationships can be provided to the system by an auditor, inferred at a later time from information received from the auditor, or through automated prompting to a supplier or manufacturer that might have access to the required information. The system may prompt the user for additional information or allow the user to acquire additional information from the team or community. Data entered or generated by the system will contain additional information as to the originator and time of origin of the data. Historical information is preserved by the system and can be used for several additional data generation such as data auditing, historical analysis, repudiation, trend or predictive analysis. The results of any such information are stored in the system database.

An auditor can gather and organize audit information using various mechanisms such as a computer connected to the network or using a mobile device with access to the network. In addition, external sensors or integrations through a programming interface can provide additional object data through the network to the system without direct user interaction. An auditor may also request information from additional sources such as a supplier, a manufacturer, team members, or the community. This information is stored in the system database.

Information such as equipment or material characteristics, local costs, installation expenses, and performance may be automatically sent by the system to a supplier or manufacturer to gather further information. In addition, it may be compared to similar information to determine potential data errors in system provided information or resulting from user entry. This information can be used to update the system database and to prompt auditors and reviewers as to a need for potential changes related to data entry errors. Costing and materials information can be used to provide more accurate energy analysis results and to update existing information which has become stale over time. These corrections or updates, the origin, and the date of origin are stored to the system database.

Reviewers and auditors may additionally specify goals such as ASHRAE audit, Energy Star compliance, LEED Gold certification or a reduction in energy usage, expenses, or green house gas emissions by specified amount. Based on these goals and the users assigned to tasks within these goals, the system can provide alternative organizations of the data or prompt auditors for additional data which is required to either achieve or document progress towards these goals. Both the goals and the gathered information are stored in the system database. These goals may be directed towards either a single building or a plurality of buildings.

After receiving and cataloging the information, the present invention can recommend specific actions based on analysis of the data, simulations, and other metrics. An auditor may choose to create a scenario to examine the impact of these recommended changes or other changes which the auditor might be inclined to research. The scenario information and the delta changes from the baseline are stored in the system database. Multiple scenarios may be created and examined by multiple users. These scenarios may be based on the baseline audit or on an existing scenario.

After a scenario is created, a reviewer or auditor may analyze the results against financial assumptions through features such as pre-defined formulas, custom integrations, and simulations. These analytics can be evaluated individually or as a group, asynchronously and/or in real time, to create result data which is stored in the system database. The system will automatically execute internal analytics to similarly create commonly used result data and store this data in the database.

A reviewer may use the analysis results data to create a plurality of reports, documentation, or filings related to business needs, bids, analysis results, legal requirements, proposed courses of action, or standards-based documentation requirements. This information is gathered and organized from the analytics and the resulting data and may be displayed, printed, exported to a file, or transmitted through the network to an external system. These reports will be stored as generated documentation in the system database and may additionally trigger a workflow for reasons such as gathering additional information or standardized submissions of the data. The system can create additional reports including a building inventory, a list of the changes and assumptions that make up a scenario, costs related to the scenario, and a bill of materials and plan for the implementation of the scenario.

The invention can manage most aspects of the requirements of for inventory and energy audits and the generation of proposed changes to existing systems. The system can also verify entered data and make recommendations as to corrections or process changes. Additionally, the system can manage payment information.

According to one aspect of the current invention, the system and method for gathering and organizing building data, data can be gathered and organized which represents physical and tangible equipment, materials, or buildings and the specific characteristics of the equipment, materials, or building required for simulating the energy consumption or creation. This may include weight and physical dimensions or technical requirements as for physical placement of the device relative to the building structure or for determining the proximity of resources to the structure. This data can originate for a system database of equipment and materials with known values, real-time sensor information, portable devices, user entry, supplier or manufacturer entry, community entry, or from derivation of data from these data sources.

According to another aspect of the current invention, the system and method for gathering common energy analysis information, object data can be gathered for one or more energy systems to be related to a plurality of buildings. The present invention can relate energy systems and gathered information that are common between buildings, and the present invention further supports analyzing the effects of replacing shared objects on the plurality of buildings. This shared information and the results data can be stored as content in a system database and content management system.

According to yet another aspect of the current invention, the system and method for automating the design of an energy system, the present invention can perform multi-variable simulations and analysis against user-configured goals and generate a proposed bill of materials and configuration of specific equipment required to meet the defined goals.

According to still another aspect of the current invention, the system and method for prediction of energy-based financial results, the present invention can perform a multi-variable simulation and gather the results data according to a user-defined configuration, assumptions, and goals to report predicted financial results of one or more scenarios.

According to another aspect of the current invention, the system and method for multi-variable energy analysis, the present inventions can use adaptive intelligence, neural networks and artificial intelligence, community and team inputs, multi-variable simulations, and/or Monte Carlo machine simulations to more accurately and reliably perform complex financial and energy analytics. A number of goal agents can be created to independently analyze data for specific results with only the most viable solutions surviving for further analysis.

According to another aspect of the current invention, the system and method for remote energy analysis, the present invention can provide a standard methodology for efficiently gathering information for a plurality of buildings to be used for systems inventory or energy analysis using mobile devices or sensors.

According to another aspect of the current invention, the system and method for display of energy and financial analysis, the present invention can organize the information on one device for presentation on a separate device in an alternative format, such as an audio presentation, Braille, or alternative visual or tactile presentation.

According to still another aspect of the current invention, the system and method for a touch based interaction with energy analysis data, the current invention can allow for examination and analysis of the energy and financial metrics using touch-screen devices to improve navigation.

According to another aspect of the current invention, the system and method for asynchronous manipulation and analysis of multi-variable energy analysis and financial data, the present invention can perform multi-variable analysis and simulation of the data to calculate results data related to energy, emissions, or financial information without requiring direct user interaction. In this manner, the present invention can calculate results data according to internal metrics that represent information that will be of likely value to the end-user, such as suggestions for alterations to the system or improved processes.

According to yet another aspect of the current invention, the system and method for comparison of energy usage and costs of two similar components, the present invention can create a simulation using a common set of assumptions for data such as finances, productivity, energy usage, and environment to allow for a normalized comparison of two individual components. The normalized systems may vary depending on the specific components being compared so as to provide a standard result index.

According to another aspect of the current invention, the system and method for determining more effective energy usage of equipment, the present invention can rank equipment and materials in a building according to a standardized set of metrics based simulations and calculations to determine the most cost-effective components to replace within a building or the most cost-effective steps to take towards understanding the energy usage characteristics of a building to reduce emissions, improve energy usage, or reach specified standards or goals.

According to still another aspect of the current invention, the system and method for determining the least efficient building and equipment, the present invention can rank buildings within a portfolio containing a plurality of buildings to determine the building which could be most cost-effectively improved or steps to implement to allow instrumentation to improve the building in order to reduce emissions, improve energy usage, or reach specified standards or goals. The details of individual buildings can be examined to more effectively understand the conclusions. According to yet another aspect of the current invention, the system and method for collaboration between individuals in a construction process, the present invention provides a system and method for real-time and asynchronous collaboration between team members in a construction process.

According to another aspect of the current invention, the system and method for offline collaboration between individuals in a construction process, the present invention provides a system and method for allowing users to collaborate on documents and perform communications while disconnected from the Internet. This system includes support for mobile devices, remote sensors, and connected computer systems.

According to another aspect of the current invention, the system and method for real-time chat collaboration between individuals using different messaging protocols, the present invention can facilitate instant-message chats using a plurality of differing instant message clients or web based chats to allow individuals communicate using their preferred messaging client or a system provided client. The resulting data is stored in the system database.

According to another aspect of the current invention, the system and method for reporting energy and financial data analysis results, the current invention can extract the data from at least one data source in response to a call from the logic module and using a report definition and the provided data, organize and display the resulting information from a plurality of multi-variable analytics processes. These individual analysis components can be individually configured by a user to create independent data objects for the reports. These independent data objects can then be associated with specific formatting components to generate the final report in a plurality of formats.

According to another aspect of the current invention, the system and method for advanced remote analysis of energy and financial data, the present invention can distribute goal agents containing a subset of the available data and an independent package of executable to a plurality of clients to enable each client to independently analyze the information and generate results. The present invention can then store and organize the results for a plurality of such requests in order to calculate complex results for a multi-variable analysis using the processors of connected client machines to distribute the workload and reduce the workload on the central system. A specific execution plan on a specific client would use program code logic defined on the central system to allow it to briefly utilize the client machine as an extension of the central system machine.

According to yet another aspect of the current invention, the system and method for performing advanced multi-variable energy analysis with previously unknown calculations, the present invention can execute formulas and analytics that are unknown to the central system. In this case, the system can interact with unknown calculation logic through one of several methodologies. In one case, it may use an external system via defined interfaces and protocols as a component of the analysis. In another case, it may allow code scripts or compiled components to execute in a sandbox environment. The custom function will be included in the calculation process and the results of this combined analysis can be included as a component of the overall multi-variable energy analysis. An alternative embodiment of this process can allow for the substitution of removal of portions of the core analysis by the customized component to allow for more specific and finer-grained analysis to be performed using customized or adapted rules. In a further alternative embodiment, the system may dynamically create new formulas and scripts that can be executed in this style to allow for adaptive or artificial intelligence agents to be created. In another embodiment utilizing such a component, the system can self-optimize internal formulas based on values that it determines can be held constant (or constrained in a narrowly defined set) in order to more efficiently approximate a result.

According to a further aspect of the current invention, the system and method for securely authenticating a remote user for an energy analysis, the present invention can allow a remote user on a mobile or handheld device to securely authenticate a remote user without requiring the user to provide a login or password. By allowing a user to send a secure URL to the remote device, it is possible for the device to be authenticated and related to the user account. In an alternative embodiment, a client certificate may be downloaded to the device to allow it to be further authenticated with the system. By using this multi-factor authentication, a user can assert their identity without requiring a password.

According to another aspect of the current invention, the system and method for securely authenticating a remote device using a previously authenticated device, the present invention can allow a previously configured remote device to connect on behalf of an unauthenticated secondary remote device. The authentication for the second device can be communicated via a known protocol (such as Bluetooth) to the primary device to allow for the device to be authenticated.

According to an additional aspect of the current invention, the system and method for relating changes in energy usage to changes in building energy systems, the present invention can gather and display data regarding the changes that have been stored within the system and relate these changes to financial and energy metrics presented to an end user. For reports or data results consisting of financial or energy information over a time period, the system can correlate changes that occurred during that time frame. For reports or data results consisting of financial or energy usage data comparisons, the changes that have been maintained in the system that occurred during the timeframe for which the data results were generated can be displayed.

The various aspects of the system may be more clearly understood and appreciated from a review of the following detailed description of the disclosed embodiments and by reference to the appended drawings. It is to be understood that both the foregoing general description and following detailed description are exemplary and are intended to provide further explanation of the invention claimed.

### BRIEF DESCRIPTION OF THE DRAWINGS

FIG. 1 is a functional block diagram illustrating the operation of the system for gathering and utilizing building energy information.

FIG. 2 is a functional block diagram illustrating the hardware architecture for a system for gathering and utilizing building energy information.

FIG. 3 is a functional block diagram illustrating the hardware architecture for the ecoEngine system.

FIG. 4 is a functional block diagram illustrating the software architecture for a system for gathering and utilizing building energy information.

FIG. 5 is a functional block diagram illustrating the software interactions of the analysis components of the ecoEngine.

FIG. 6 is a functional block diagram of the login/logout process.

FIG. 7 is a flowchart depicting the configuration of a remote device to automatically be authenticated by the ecoEngine system.

FIG. 8 is a flowchart depiction of the main menu navigation for the system.

FIG. 9 is a flowchart depicting the process of creating and configuring a new building.

FIG. 10 is a flowchart depicting the methodology for organizing the buildings.

FIG. 11 is a flowchart depicting the methodology for organizing data objects.

FIG. 12 is a flowchart depicting the process for creating a new scenario.

FIG. 13 is a flowchart depicting the administrative menu navigation.

FIG. 14 is a flowchart depicting the process of creating and executing an Analysis function object.

FIG. 15 is a flowchart depicting the creation and usage of a report consisting of Analysis function objects.

FIG. 16 is a flowchart depicting the logic of the asynchronous background tasks used for the handling of the ecoEngine system data and the creation of new data based on data entering the system.

FIG. 17 is a high-level architectural diagram of the chat system in the ecoEngine used to communicate with multiple chat clients using potentially different IM software.

FIG. 18 is a flow diagram illustrating the manner in which the ecoEngine receives emails for team collaboration.

FIG. 19 is a high-level illustration of the method used for allowing a secondary presentation device to communicate an alternative presentation of the information being displayed to a connected client device.

FIG. 20 is an illustration of a method and system for visualizing the causal relationship of a change against a chart containing data such as financial or consumption metrics.

### DETAILED DESCRIPTION

The described embodiment discloses a system for gathering and utilizing building energy information. This system, referred to as the “ecoEngine”, is designed to receive and efficiently organize and utilize energy usage information for a plurality of buildings. Although the described embodiment refers to specific analysis and forecast types such as water usage analysis, carbon analysis, DOE-2 Energy analysis, weather simulation, and energy forecasts, those skilled in the art can readily appreciate the system is equally advantageous in other scenarios relating to building energy usage modeling and the related financial analysis. Similarly, those skilled in the art can appreciate that the system can be advantageous for achieving other financial or compliance goals in addition to specific examples provided such as reducing energy usage, reducing greenhouse gas or carbon emissions, and achieving a standard such as LEED or Energy Star.

The disclosed embodiment provides a system for gathering and utilizing the energy usage data for a plurality of buildings over the life of the building. It simplifies and standardizes the processes required to gather and organize such data and provides a way to compare multiple complex modifications to determine the most efficient strategy for meeting specified goals.

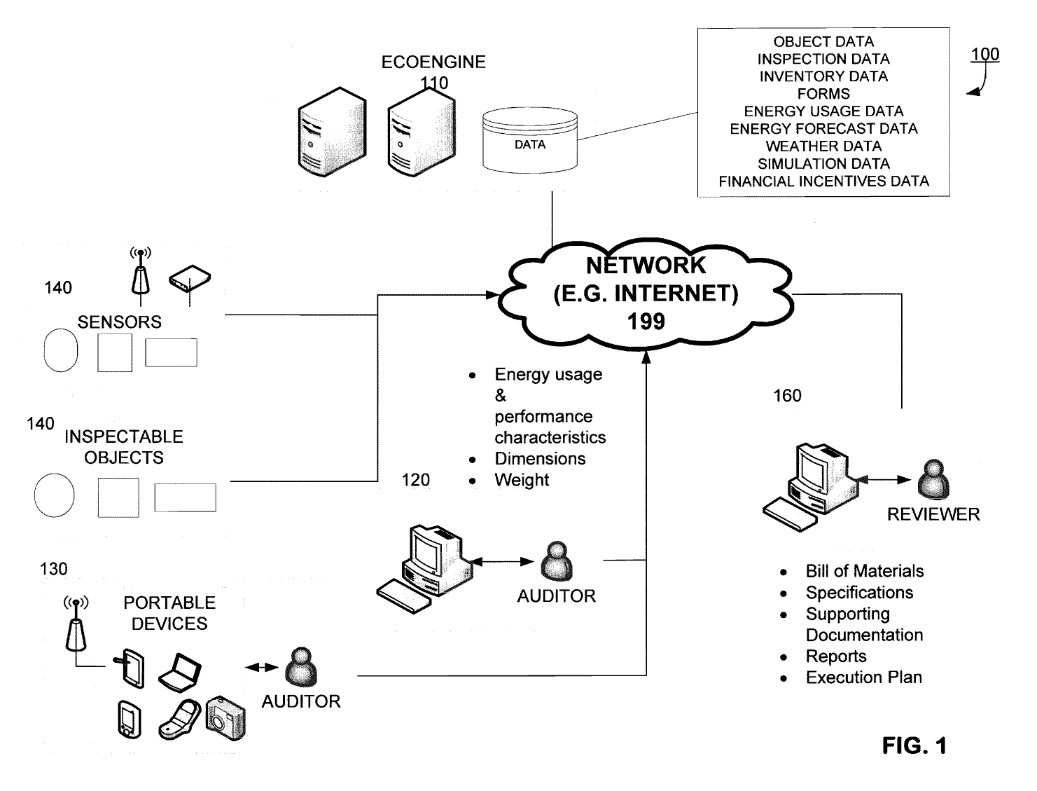

Turning to the figures in which numerals indicate like elements throughout the several figures, FIG. 1 illustrates and overview of the system 100 constructed in accordance with the embodiment of the present invention. The ecoEngine 110 is connected for computer communications via a known global computer network referred to as the Internet 199 and stores object data, organizes the stored data, provides a standardized auditing procedure, validates incoming information, performs simulations, generates reports and facilitates other functions for gathering and utilizing energy usage data for a plurality of buildings.

Data object information such as energy usage characteristics, performance characteristics, dimensions, weight, and location can be provided to the ecoEngine 110 over the Internet 199 by an Auditor using a computer system 120 connected to the Internet 199 or by an auditor gathering information using one or more portable devices 130 which can connect wirelessly to the Internet 199. Such portable devices allow an Auditor to visually inspect a plurality of inspectable objects 140 examples of which include HVAC&R systems, lighting systems and building shell characteristics. Those skilled in the arts will also recognize additional systems which could be inspected, inventoried, and audited using the present invention. Additionally, those skilled in the art will recognize that a number of such inspectable objects can utilize sensors and smart meters 140 which can communicate such information directly to the present invention without the need for an Auditor to be present. A Reviewer 160 which may include a financial officer to accountant can then examine the inventory of inspectable objects and related object and inventory data. Using the data stored in the ecoEngine 110, the Reviewer can related this information to additional stored data such as energy forecast data, weather data, financial incentives, and simulation results to better understand the energy usage of the building and its financial effects. Similarly, the Review may choose to examine a plurality of scenarios which may involve the substitution of inventoried inspectable objects or changes in pricing to determine the financial effects and generated a corresponding set of documentation regarding these changes, such as a bill of materials, specifications, supporting documentation, general reports, and an execution plan to implement the substitutions or changes on one or more buildings.

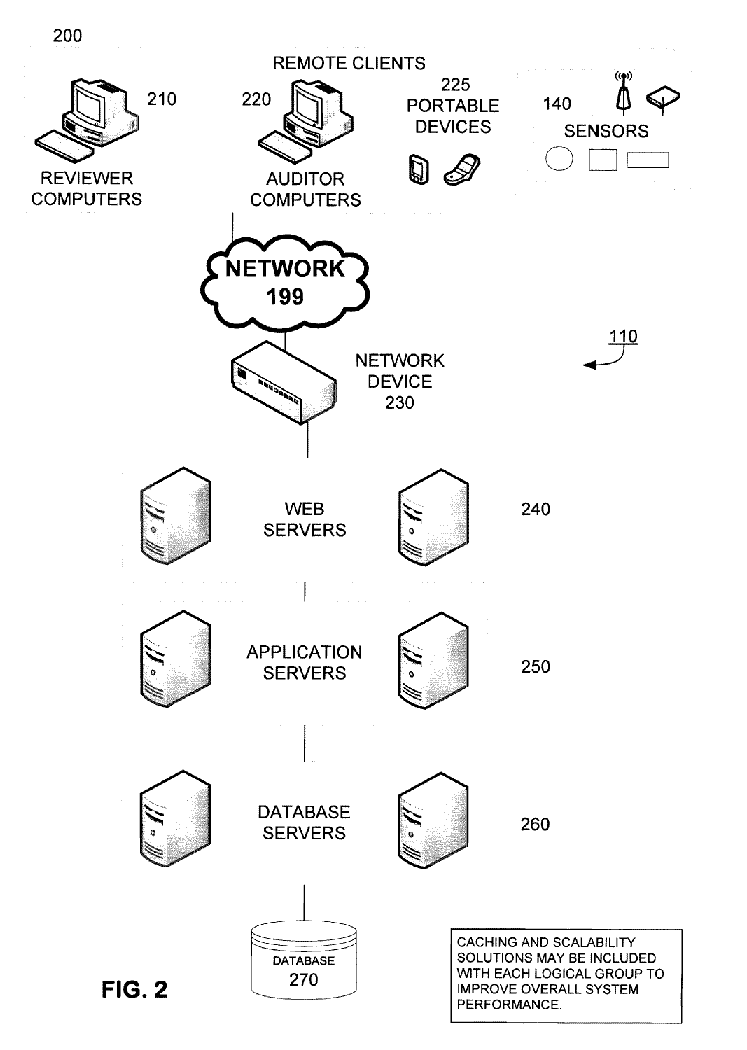

Turning to FIG. 2, those skilled in the art will recognize a high level hardware architecture diagram showing the connections of components of this system to the configured ecoEngine 110 constructed in accordance with an embodiment of the present invention. Remotely connected systems 200 such as the Reviewer computers 210, the Auditor computers 220, portable devices 225, and sensors connected to inspectable objects 140 communicate with the present invention using a network 199 such as the Internet. The ecoEngine 110 receives this communication through an attached network device 230 and provides it to the web servers 240 which are responsible for exposing services such as a communications interface and a graphical, web based viewing system. Interactions with these machines result in information being communicated to the Application Servers 250 which are responsible for manipulating the information and providing the core functionality of the system. The communication and any generated data results are stored using the database servers 260 to place this information info a system database 270. Those skilled in the art will recognize that other systems may be present to improve performance, security, and scalability to the overall system.

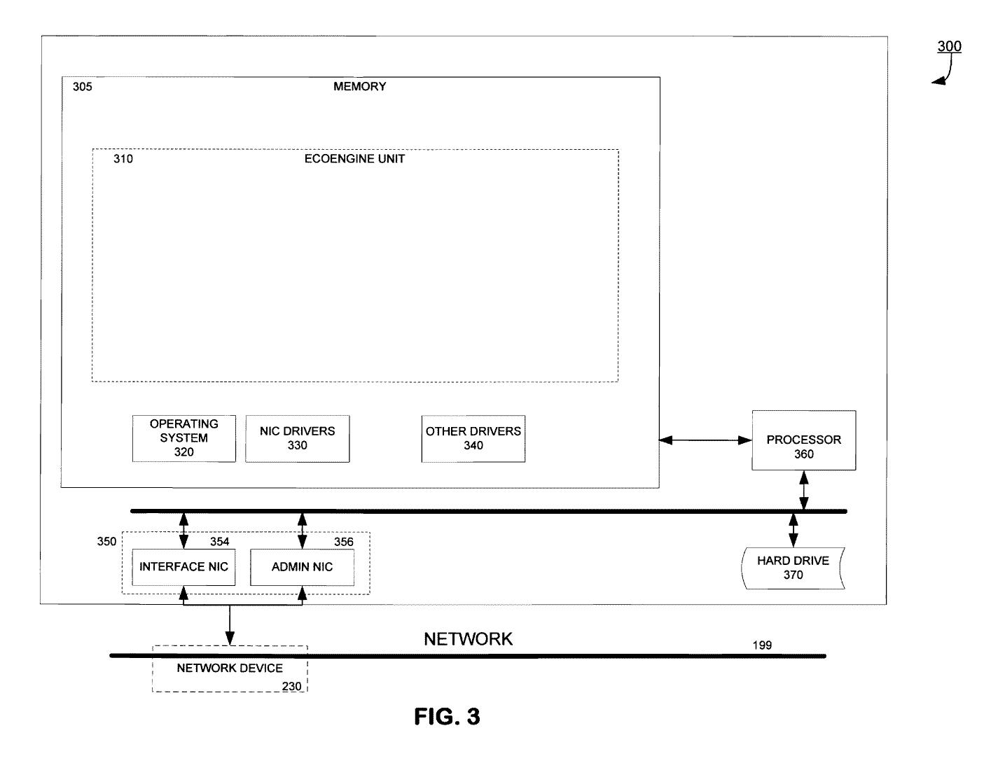

In FIG. 3 we can see a high level hardware diagram of the preferred hardware configuration for a server 300 that executes the functions of the above described ecoEngine system, constructed in accordance with an embodiment of the present invention. The server 300 consists of memory 305 used to contain the executing the code functions for the ecoEngine unit 310. Communication with the network 199 is made by using NIC (network interface card) drivers 330 to transmit and receive information from one or more NICs 350 which can send and receive data from the network device 230 connected to the network 199. The preferred configuration of such a system contains two NICs 350. The interface NIC 354 is used for communications with the network intended for remote clients as described above. The admin NIC 356 is intended for connection to other similar systems and for use in diagnostics of the system. One skilled in the arts will readily recognize the advantages of this configuration and that additional NICs may be added or that the two NICs may be replaced with a single NIC which can serve both purposes.

The operating system 320 of the server preferably needs to be compatible with the network cards 350 and other hardware devices of the server 300. One operating system 820 which can be utilized is Microsoft Windows. One skilled in the art will recognize that other operating systems, such as LINUX may be substituted. As on skilled in the art will know, the operating system 320 is responsible for controlling the operations of the processor 360. This processor 360 interfaces with the memory 305 and other drivers 340 to execute the program code of the ecoEngine unit 310. The code for the ecoEngine unit in the preferred system is loaded from the hard drive 370 and placed into memory for execution by the operating system 320. Temporary data and logs generated by the ecoEngine unit 310 may be stored on the hard drive 370 for later use or for forensic analysis.

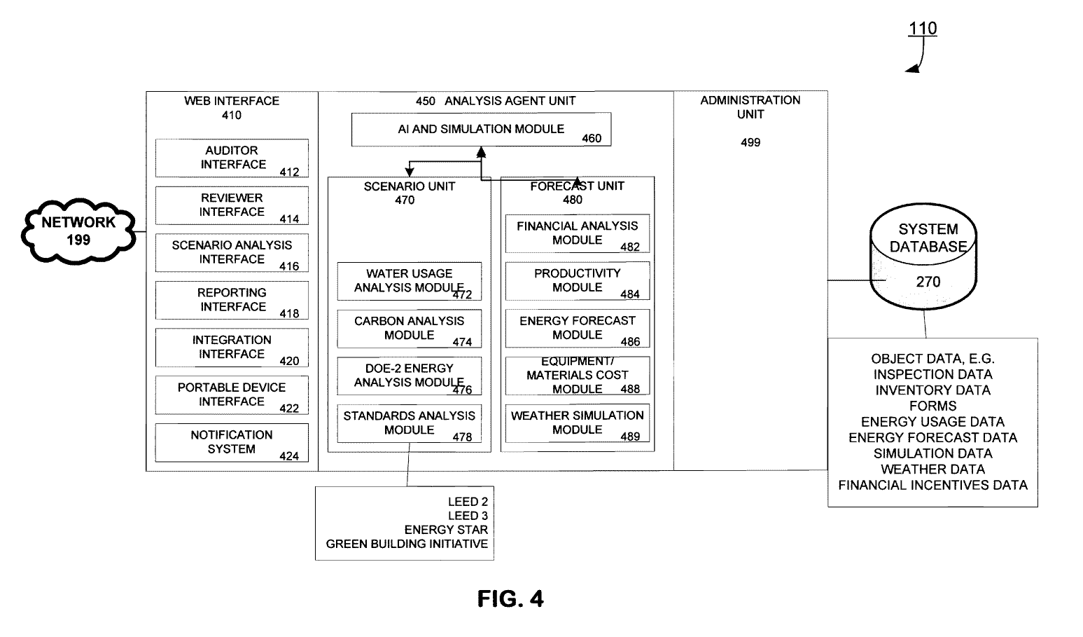

Turning to FIG. 4, we see a software architecture view as would be used by one skilled in art to visualize the design of the ecoEngine 110 as connected to the network 199. Connected users and devices as described above interact with the system through communications to the Web interface 410. The interface 410 consists of a number of more specific interfaces; those skilled in the art will recognize that other interfaces might be available for scalability, performance, diagnostics, or other reasons. Examples of available interfaces would include the Auditor interface 412 which is displayed to an Auditor as described above to provide a visual interface for entering and reviewing data related to a building, its inspectable objects, and the related energy usage details. Similarly, a Reviewer interface 414 provides a user interface to allow a Reviewer to examine the entered data, the characteristics of the systems, and the related effects of the system relative to user defined interests and goals such as energy usage, greenhouse gas emissions, and standards compliance. A specialized scenario analysis interface 416 is used to examine the effects of replacing one or more of the inspectable objects with similar or more efficient objects. This scenario analysis interface 416 can also be used to explore the addition, removal, or reconfiguration of components of the system and the resulting effects. A reporting interface 418 is provided to support the creation of reports which may be exported, distributed, communicated electronically, displayed or otherwise visualized containing user-configured and defined information and analytical results. An integration interface 420 is provided to allow sensors and additional systems to more efficiently communicate with the present invention using a known application programming interface (API). The methodologies and usage of such an interface will be obvious to one skilled in the art. As an example, such an interface could be used to provide the ability to collected related information from an external system or to store gathered data from the present invention to a remote system. In order to provide a more specialized user interface for auditors using portable devices, a portable device interface 422 is utilized. This can provide said users with a more intuitive experience that can consider the limitations and features of such devices. One skilled in the arts will recognize that such an interface is necessary due to the significant differences in screen size and features that exist in portable devices and due to limitations or features present on such devices that are not available through a web browser. For these reasons, one skilled in the art will recognize that portable devices may use both the integration interface 420 and the portable device interface 422. For communications intended to be broadcast or transmitted to users or drives outside the system for alerts, notifications, or collaborative conversations, a notification system 424 is employed. This specialized interface provides an optimized messaging system for the transmission of information from the present invention to a connected remote device.

These web interfaces 410 communicate information to the analysis agent unit 450. This unit is responsible for analyzing and storing the gathered data and using that data to generate additional data or to compare datasets. This analysis and manipulation can occur in response to user activity in the web interface 410 or in an asynchronous manner. In the asynchronous manner, the system can trigger additional analysis based on additional factors such as user defined conditions, external triggers, or time-based scheduling. This unit contains the AI and Simulation module 460 which is responsible for performing the actual analysis and storing the results. This module will, in the preferred configuration, additionally create new executable code and analysis components to allow it to more effectively and efficiently perform the analysis objectives. Such adaptive or artificial intelligence is recognizable to someone in the art as a means of analyzing complex data sets. Such usages are not observed with energy analysis applications as they are not obvious to those skilled in that particular art. The AI and simulation module 460 works generally to relate information gathered through the web interface to potential changes and simulations through a scenario unit 470. This scenario unit 470 can perform complex analysis of data from buildings and observable objects as described above to generate additional data regarding the characteristics of those objects. For example, a water usage analysis module 472 could be used to determine how much water is utilized by the building and the observable objects over a period of time. Similarly, a carbon analysis module 474 could calculate the related greenhouse gas emissions in carbon equivalency units. A DOE-2 or similar energy analysis module 476 could simulate more specific energy demand and generation characteristics in a specific environment over a period of time. A standards analysis module 478 could examine the results data from other modules and the configured information gathered and stored in the system to determine potential compliance or noncompliance with standards such as LEED 2, LEED 3, Energy Star, or the Green Building Initiative.

In order to perform the analysis and determine potential financial impacts, a forecast unit 480 provides information regarding forecasted or expected model behaviors. This can include a financial analysis module 482 which can examine the expected financial costs as related to the results of a configured analysis in a scenario unit 470. A productivity module 484 could provide modeled characteristics as to the expected employee absenteeism and productivity given the available information and characteristics. Because the cost of generating energy and the related emissions varies over time, an energy forecast module 486 provides a means of determining the expected costs based on specific data models. Any change has related costs of materials, labor, and maintenance which the system provides through an equipment and materials cost module 488. Since energy consumption can grow or diminish based on local and regional weather events, a weather simulation module 489 can provide required information as to expected weather conditions for a specific location at a specific date and time.

An administration unit 499 provides support for performing administration of the system, configuration settings, and contents. The configuration data as well as data received through the web interface 410 or generated through the analysis agent 450 is stored to the system database 270.

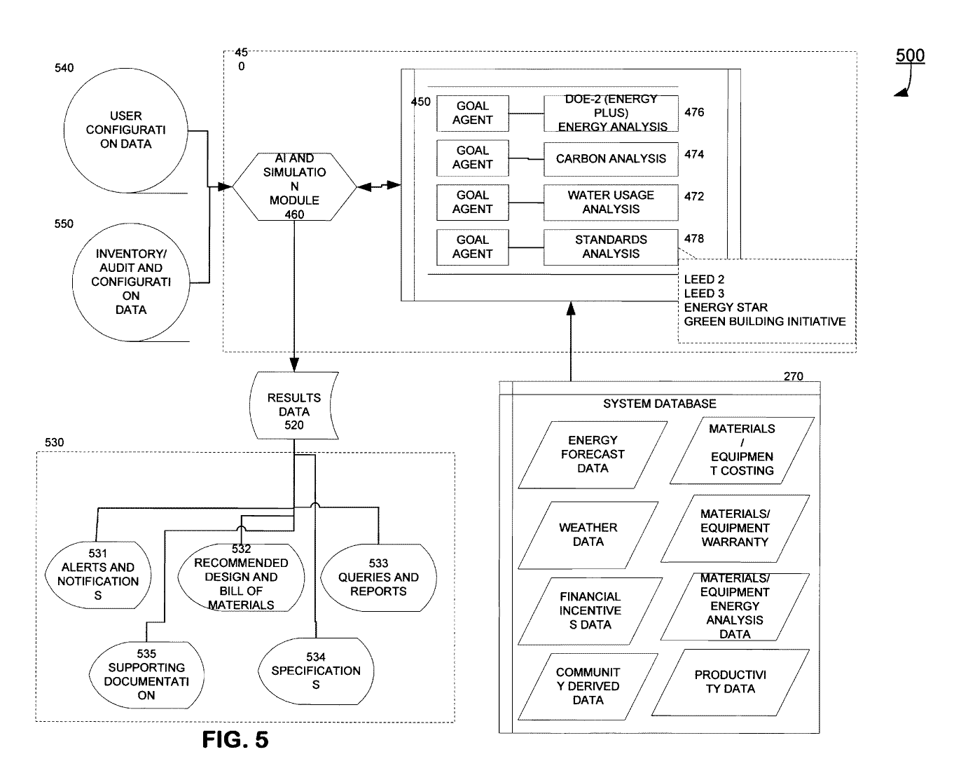

Continuing to FIG. 5, we can see a more specific software architecture diagram showing the relationship 510 of the Analysis Agent Unit 450 to other parts of the system. User configuration data 540 and inventory/audit configuration data 550 are used by the AI and Simulation module 460 to schedule and parallel execute goal agents 510. These goal agents 510 can perform a plurality of analysis operations as previously described in order to either generate additional data or to attempt to resolve the data towards a specified goal as described previously. These goal agents 510 can also read data stored in the system database 270 that might be required to perform the analysis, such as energy forecast data, weather data, financial incentives data, costing data, warranty data, equipment/materials energy analysis data, and productivity data. The results are provided to the AI and simulation module 460 which then stores this results data 520. The preferred storage for this results data is the System Database 270. This results data is then utilized by the present invention for a number of purposes 530. Some examples of such usage is as a trigger for alerts and notifications 531, to generate a recommended design and the related bill of materials 532, to support queries and reports 533, to generate supporting documentation 535, and to document requirements and compliance with user-specified standards specifications 534.

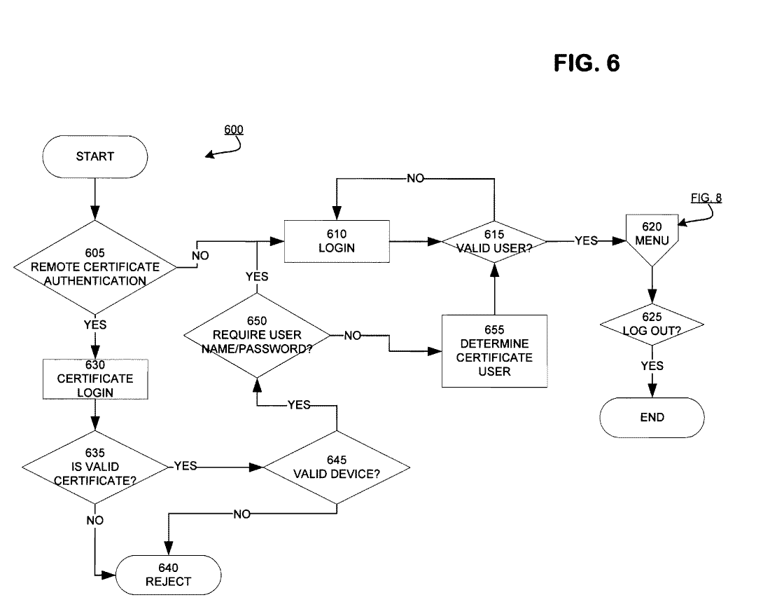

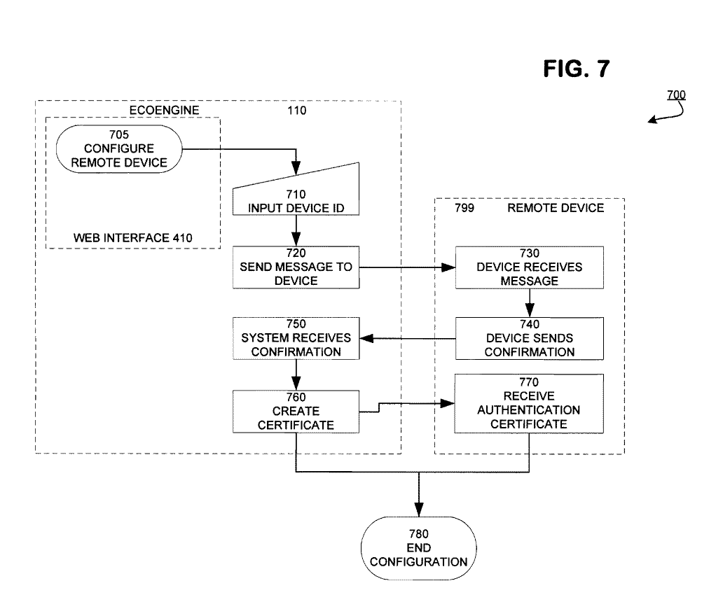

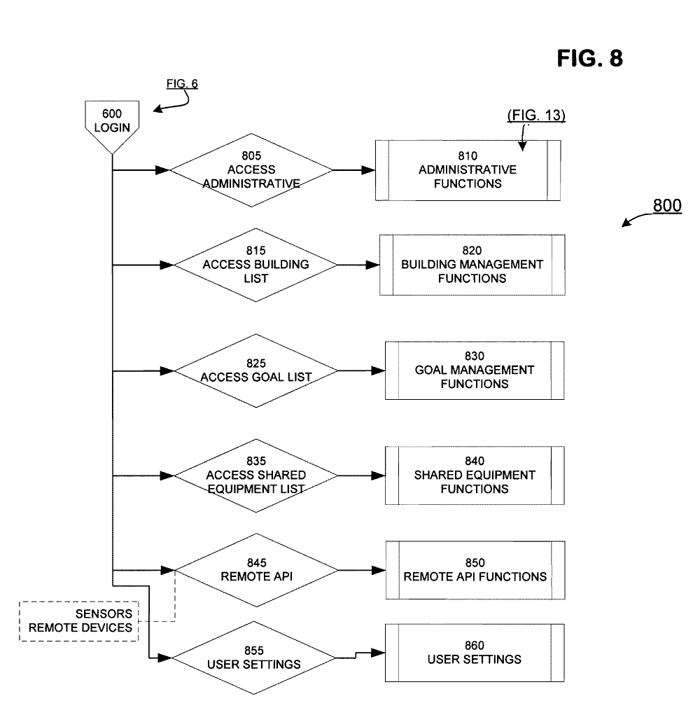

Moving to FIG. 6, we can see the login process 600 for the present invention. Portable or remote devices have the opportunity to perform a remote certificate-based authentication as in step 605. This will be discussed in more detail in FIG. 7, below. For devices that perform this form of authentication, they can transmit a client certificate to the present invention's web interface 410 via a secure protocol such as HTTPs to initiate a secured certificate authentication as shown in step 630. The manner of such a transaction is known to those skilled in the art, although it is generally unknown to those involved in energy audit operations. If the certificate is not valid as indicated in step 635, the authentication request is rejected as illustrated in step 640. If the certificate is validated 635, the system will determine if the certificate matches a known device which is enabled to login to the system in step 645. If it does not match, the authentication is rejected in step 640. For greater security, an administrative setting in the present invention can force an additional authentication by requiring the related user name and password in step 650. This setting can be disabled to allow for a means of authenticating devices without requiring a user/password login. In this case, as shown in step 655 the user account related to the certificate will be determined by the present invention and tested for to determine if the user account is valid as tested in step 615 and allowed utilize the ecoEngine. For users performing a direct login or for remote device logins which require a user name and password, a full login in step 610 will be required. In this case, a user name and password will be provided and validated in step 615 as described above. It is recognized by those skilled in the art that restrictions on the number of login attempts and the characteristics of the password will be implemented in accordance with generally accepted security standards. This will include rejecting users if the number of login attempts is exceeded. If the user/password cannot be validated by the system, the user is either rejected in step 640 or prompted to login again by returning to step 610. Those skilled in the art will recognize that the authentication of a user account may occur within the system or may be redirected to be performed externally; those skilled in the art will also recognize that other security standards may be implemented such as CAPCHA. If the user can be validated successfully and authorized in step 615, they will be presented with the main menu as appropriate for that user as denoted by step 620. This is discussed further in FIG. 8. At any time, a user may select to log out (step 625) of the system which will cause them to exit the ecoEngine software. Those skilled in the art will recognize that step 625 may also be used to allow the user to log out for the purpose of entering the system using a different user account and login.

Continuing to FIG. 7, we see an overview of configuring a remote device for authentication with the system 700. While in the Web interface 410 of the ecoEngine 110, a user with appropriate permissions may choose to proceed to step 705 and configure a remote device 799 for access. The details for the device are entered into the system along with a unique identifier for the device 710. This unique identifier entered in step 710 is preferred to be a hardware level identifier that is recognizable. The preferred identifier for a mobile phone based device is the phone number associated with said device. The purpose of the identifier is to allow the system 110 to send a message to the device in step 720 which only the specified device will receive. Those skilled in the art will recognize that other such transmissions are possible using other communication technologies. In an alternative embodiment, a configured device can provide this connection to allow a direct association of the two devices for this purpose using a communication standard such as Bluetooth. In step 730, the device 799 receives the messages and responds with a confirmation to the system 110 in step 740. The preferred confirmation is a web based link that allows the remote device 799 to perform an HTTPS based request to a unique confirmation URL from the system 110. In this preferred manner, this confirmation URL is time limited and valid for a single device. Those skilled in the art will recognize that other manners of secure remote connection are available, such as a SOAP based web-service using WS-Security. This confirmation message is received in step 750 and the remote certificate is created and stored in the system 110 as a valid certificate in step 760. This certificate is transmitted to the remote device 799 for use in future communications. Those skilled in the art will recognize that a system 700 will include additional features for marking such a device or certificate as no longer valid and for expiring such certificates after an elapsed time. With the transmission of the certificate, the configuration is completed in step 780.

After a successful login as described in FIG. 6, a user of the system would be presented with a menu such as the one illustrated by a flowchart in FIG. 8. This menu system 800 would present a number of menu options to the user as exemplified in FIG. 8. Those skilled in the art will recognize that other menu items may exist and that menu items may be visible or hidden based on restrictions to the user's account; they will similarly recognize that menu items can be nested within other menu items or renamed/rearranged to provide a more user-friendly experience.

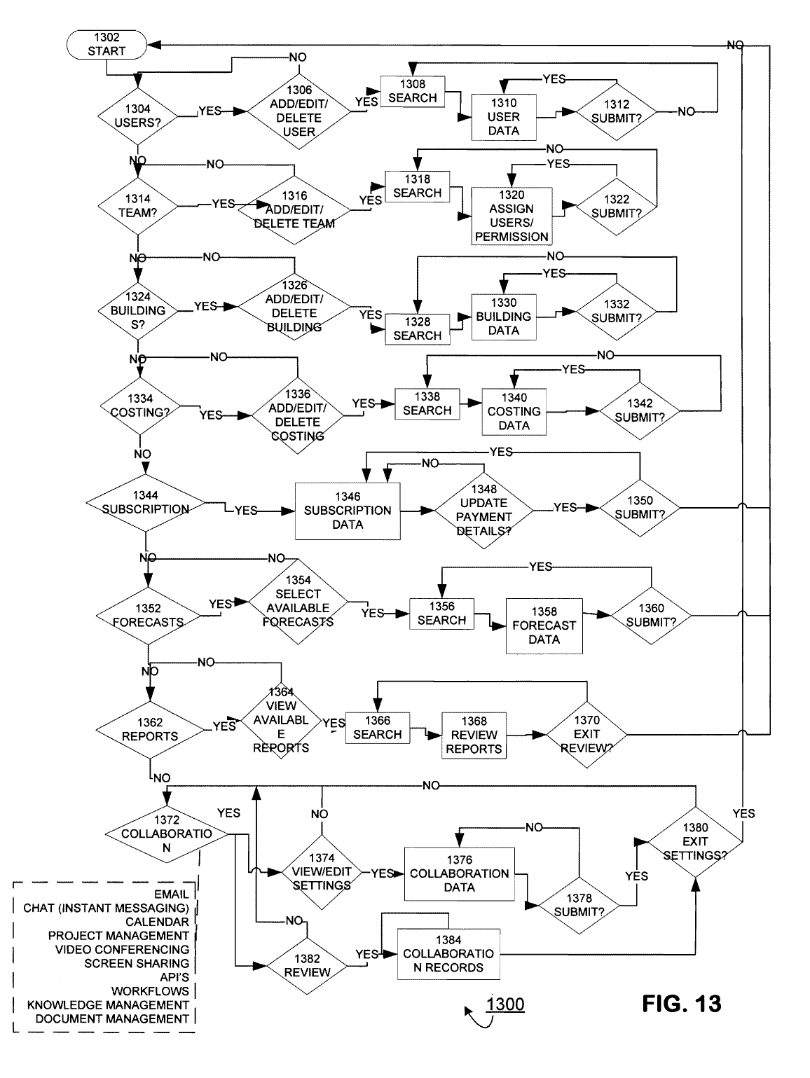

If the user has permission and chooses to access the administrative functions in step 805, the user will be presented with the menu and navigation options 810 for the administrative functions of the system. This particular situation is covered with more exemplary details in FIG. 13, detailed below. Similarly:

If the user has permission and chooses to access the building list in step 815, the user will be presented with the menu and navigation options 820 for the plurality of buildings the user has access to configure, analyze, audit, or report against.

If the user has permission and chooses to access the goal list in step 825, the user will be presented with the menu and navigation options 830 for the creating, viewing, and editing goals.

If the user has permission and chooses to access the shared equipment list in step 835, the user will be presented with the menu and navigation options 840 for the creating, viewing, editing and editing shared equipment data as well as options for associating shared equipment with a plurality of buildings.

If the user has permission and the connecting device is enabled for remote connections as previously described and the device chooses to utilizes the remote API in step 845, the user will be presented with information exposed by the remote API functions in 850. If the user has permission and chooses to access the user settings in step 855, the user will be presented with the menu and navigation options 860 for the user-specific configuration settings.

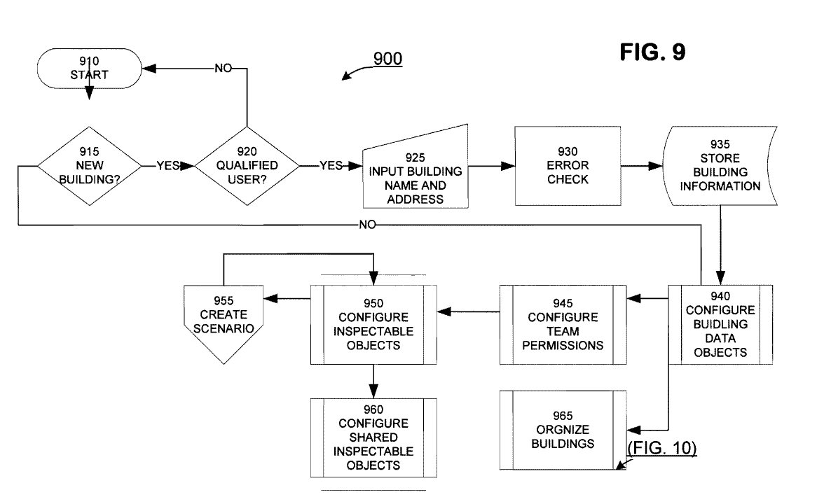

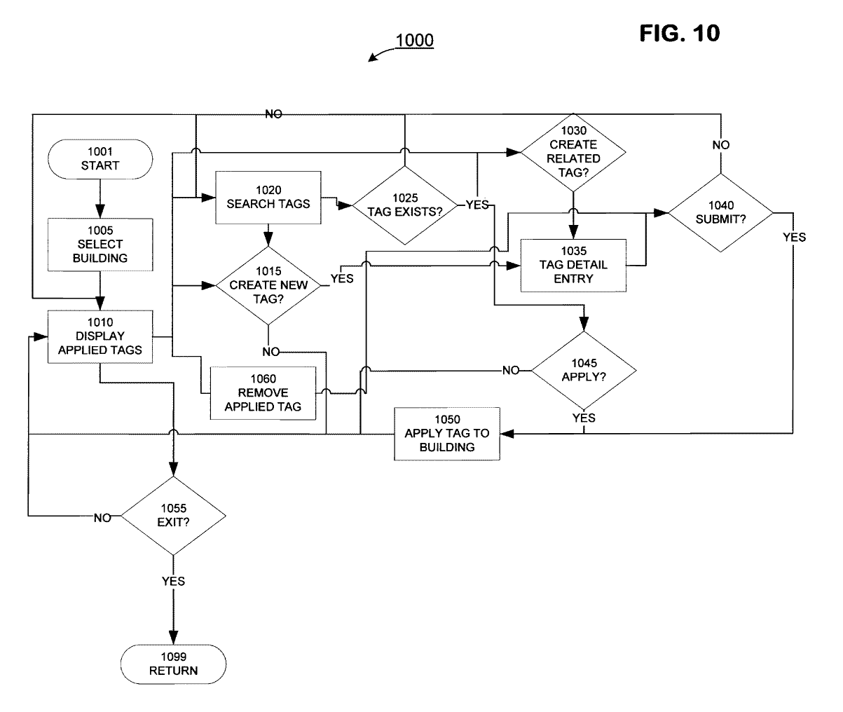

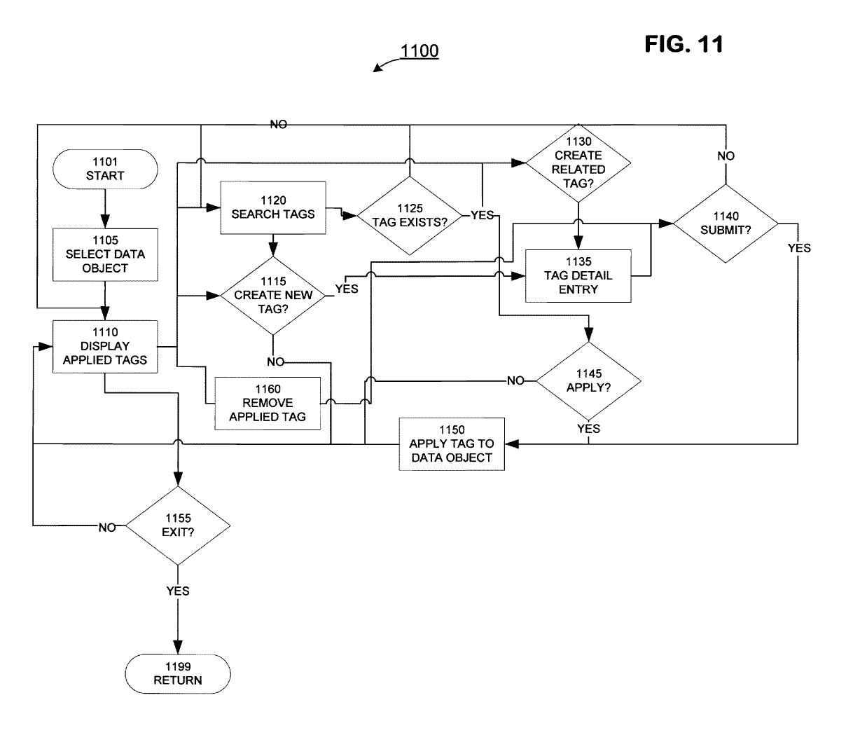

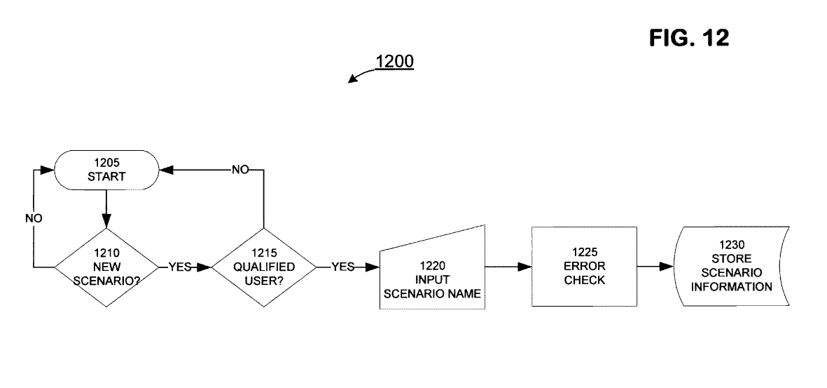

Moving to FIG. 9, the overview of the new building data entry process 900, the Auditor would enter the system at step 910 and be presented with an option to create a new building as in step 915. If the user is qualified by the system in step 920—typically via permissions from an administrative user—the user will be allowed to continue and enter the name and address of the building in step 925; otherwise, the user is returned to the start of the process at step 900. The present invention will then check the data for validity in step 930 and prompt the Auditor to correct any mistakes detected. If no errors are present, the present invention will store the buildings information at step 935 and present the Auditor with the ability to configure the building data objects as illustrated by step 940. The user may then choose to configure the team permissions in step 945, organize the building within the present invention in step 965 as detailed in FIG. 10, or begin the process of configuring inspectable objects in step 950. Within step 950, an Auditor may choose to organize the equipment as details in FIG. 11. From step 950, the Auditor may choose to share an inspectable object with other buildings in step 960 or create a new scenario in step 965 which is detailed in FIG. 12. A scenario is best defined as a set of changes to the building or configurable object definitions towards achieving a user-defined objective, most usually associated with the system as a goal.

Proceeding to FIG. 10, a flow chart illustrating the organization process for a building 1000. When the Auditor starts this process at step 1001, they will be prompted to select an available building in step 1005 if one is not already selected. This selection process will be organized using tag clouds, hierarchical tag displays in which the tags appear as folders, or as alphabetically arranged tags depending on a user preference which would be configured in the user settings described above. The present invention will display any tags applied to the current building in step 1010. The user may choose to create a new tag in step 1015. In this case, the user would be prompted for the name and an optional description for the tag in step 1035. The user may then submit the tag in 1040 and save the information to the system database; the tag will then be applied to the building in step 1050 and the user will see an updated list of tags in step 1010. If the user does not submit the tag, the user is returned to the previous displayed of applied tags, step 1010.

Should the user choose an existing tag in 1010, the user may choose to remove the applied tag in step 1060; submitting this change in step 1040 will remove the tag from the building and redisplay the tag list in step 1010. Alternatively, the user may select a tag and chose to proceed to step 1030 and create a related tag. In this case, the user would then proceed to step 1035 to create the new tag as detailed above. If the tag is then submitted in 1040, the tag will have a child relationship to the tag originally chosen. As a further alternative, the user may search for an existing tag in step 1020. If the tag does not exist, the user will be returned to step 1020 to search again. If the tag exists, the user can choose to either create a related tag as detailed previously for step 1035 or the user can choose to apply this new tag in step 1045. At any point, the user may chose to proceed to step 1055 to exit the organization screen. The user will then proceed to step 1099 and return to the building page that started the flow.

Proceeding to FIG. 11, a flow chart illustrating the organization process for data objects related to the current building, the flow 1100. The term data objects represents for the purposes of this flow any inspectable object data as well as any system-generated information that is allowed to be tagged. When the Auditor starts this process at step 1101, they will be prompted to select a data object in step 1105 if one is not already selected. This selection process will be organized using tag clouds, hierarchical tag displays in which the tags appear as folders, or as alphabetically arranged tags depending on a user preference which would be configured in the user settings described above. The present invention will display any tags applied to the current data object in step 1110. The user may choose to create a new tag in step 1115. In this case, the user would be prompted for the name and an optional description for the tag in step 1135. The user may then submit the tag in 1140 and save the information to the system database; the tag will then be applied to the data object in step 1150 and the user will see an updated list of tags in step 1110. If the user does not submit the tag, the user is returned to the previous displayed of applied tags, step 1110.

Should the user choose an existing tag in 1110, the user may choose to remove the applied tag in step 1160; submitting this change in step 1140 will remove the tag from the data object and redisplay the tag list in step 1110. Alternatively, the user may select a tag and chose to proceed to step 1130 and create a related tag. In this case, the user would then proceed to step 1135 to create the new tag as detailed above. If the tag is then submitted in 1140, the tag will have a child relationship to the tag originally chosen. As a further alternative, the user may search for an existing tag in step 1120. If the tag does not exist, the user will be returned to step 1120 to search again. If the tag exists, the user can choose to either create a related tag as detailed previously for step 1135 or the user can choose to apply this new tag in step 1145. At any point, the user may chose to proceed to step 1155 to exit the organization screen. The user will then proceed to step 1199 and return to the building page that started the flow.

Next, in FIG. 12 we see the process 1200 for creating a new scenario. Starting at step 1205, the user can choose in step 1210 to create a new scenario. If the user is not qualified by the system in step 1215 to create a scenario, the user is returned to the start of the process in step 1205. In the preferred expression of the invention, the user should be prevented from seeing any menu items for creating a scenario and thus not be exposed to this flow. If the user is qualified in step 1215, the user can input a new scenario name in step 1220. The system will perform error checks in 1225 such as making sure there is not another scenario of the same name and that the name is not empty. If these checks fail, the user will be prompted to correct the error. Otherwise, the user proceeds to step 1230 and the scenario name is persisted. The user will then be operating inside the scenario. This means that any information that the user manually enters while within the scenario about the plurality of buildings or related data objects or shared observable objects will be associated with the scenario. This allows the user to change these objects and analyze the impact of the changes without modifying the original building or inspectable object definitions for the original building.

In FIG. 13, we can see more details about the administrative functions 1300 of the present invention in flowchart form. The process begins by the user selecting a specific administrative action from among several presented. Those skilled in the art will recognize that similar to the main menu page, these options may vary according to permissions and user experience needs.

If the administrative user chooses the User step 1304, the administrative user can proceed to step 1306 and add, edit or delete users from the system. The administrative user may choose to proceed to search for and select a user in step 1308. The data for the user may then be viewed or edited in step 1310 and submitted in 1312. The submitted changes are persisted to the system database.

If the administrative user chooses the Team step 1314, the administrative user can proceed to step 1316 and add, edit or delete teams from the system. The administrative user may choose to proceed to search for and select a team in step 1318. The data for the team and users or permissions associated with the team may then be viewed or edited in step 1320 and submitted in 1322. The submitted changes are persisted to the system database.

If the administrative user chooses the Buildings step 1324, the administrative user can proceed to step 1326 and add, edit or delete buildings and the related data object information from the system. The administrative user may choose to proceed to search for and select a building in step 1328. The data and permissions for the building may then be viewed edited in step 1330 and submitted in 1332. The submitted changes are persisted to the system database.

If the administrative user chooses the Costing step 1334, the administrative user can proceed to step 1336 and add, edit or delete price and costing information from the system. The administrative user may choose to proceed to search for and select priced equipment, materials, or labor in step 1338. The data for the selected item may then be viewed or edited in step 1340 and submitted in 1342. The submitted changes are persisted to the system database.

If the administrative user chooses the Subscription step 1344, the administrative user can proceed to step 1346 and current subscription and billing information within the system. The administrative user may choose to proceed to view or update the details for the preferred manner of payment for use of the system in 1348. The data for the updated payment details may then be submitted in 1350. The submitted changes are persisted to the system database.

If the administrative user chooses the Forecasts step 1352, the administrative user can proceed to step 1354 and view or customize available forecasts. The administrative user may choose to proceed to search for and select a forecast in step 1356. The data for the forecast may then be viewed or edited in step 1358 and submitted in 1360. The submitted changes are persisted to the system database.

If the administrative user chooses the Reports step 1362, the administrative user can proceed to step 1364 and view or available reports which have been previously created. The administrative user may choose to proceed to search for and select a report in step 1366. The report may then be viewed in step 1368. The administrative user may choose to return to 1366 and search for a new report to view or choose to exit the review in step 1370. The submitted changes are persisted to the system database.

If the administrative user chooses the Collaboration configuration step 1372, the administrative user can proceed to step 1374 and view or edit collaboration related settings in step 1376; these changes may be submitted in step 1378. The submitted changes are persisted to the system database. Alternatively, the administrative user can choose to proceed to the Review step 1382 and select and view any existing collaborative events which have been stored within the system. In the preferred configuration, this would include additional support for searching and reviewing the records based on various conditions, record type, or source. At any point within the Collaboration configuration items, the administrative user may choose to exit viewing in step 1380.

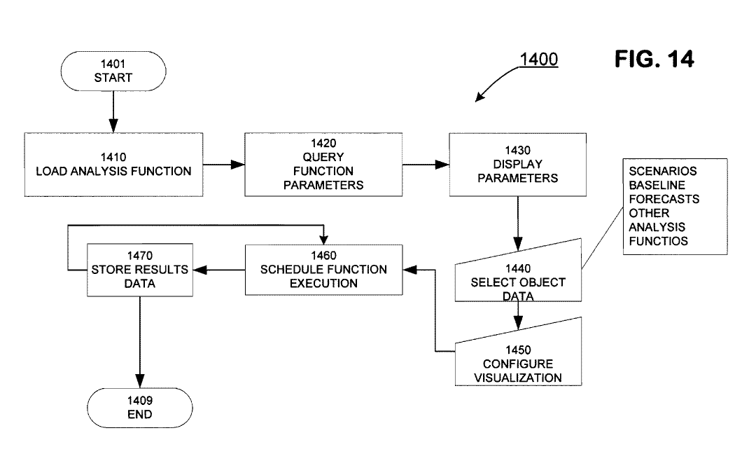

Proceeding to FIG.14, we can see a high level overview 1400 of the creation of an Analysis component. Entering this process at 1401, the Reporter can proceed to step 1410 and select and load an Analysis function. As someone skilled in the art would known, the manner of searching and selecting for a function can be varied. In step 1420, the system will query the function to programmatically determine the required parameters for the function. These parameters are displayed to the Reporter in step 1430 and appropriate values (examples of which are existing scenarios, a baseline building entry, forecasts, or other configured analysis functions) can be selected by the reporter in 1440. In 1450, the user can configure a related visualization (examples of which are charts, graphs, and tables) which can be used to display the results. The system will then schedule the function to execute in step 1460 and store the results data from that execution in step 1470. The system or the function may automatically repeat step 1460 as required or as the source data sets change. The process ends at step 1409.

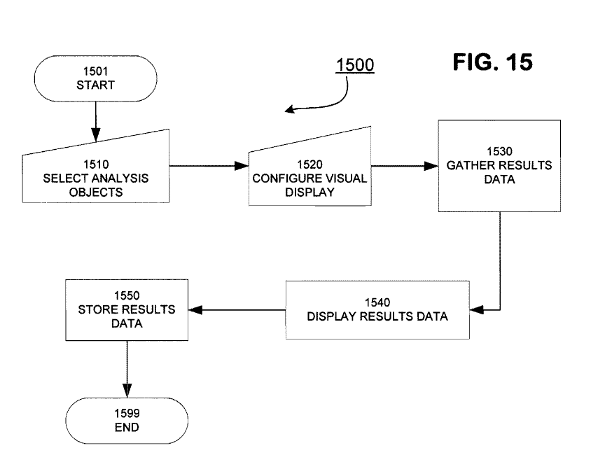

In the next figure, FIG. 15, is a flowchart which provides an overview of the creation of a report. This process 1500 begins with step 1501 and proceeds to step 1510 with the Reporter's selection of one or more Analysis objects created in FIG. 14 for display in a report. Proceeding to step 1520, the Reporter can configure the preferred visual display to be used for presenting the Analysis object's data results within the report. In step 1530, the present invention will gather the results data and proceed to 1540 where the results are displayed as configured, previously described, on a display device such as a computer monitor. The results of the report may be stored in step 1550. Those familiar in the art will recognize that the report's storage may be in a number of forms including to the system database, to a downloadable file format, or some understood form of electronic transmission to an external system.

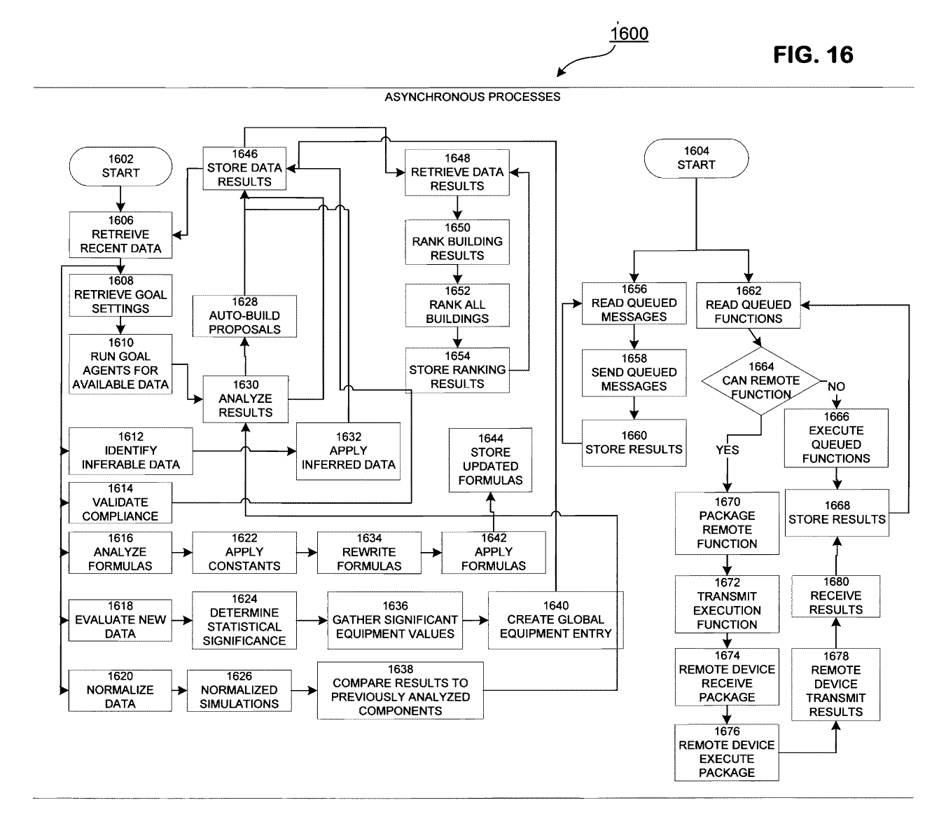

The next figure, FIG. 16, displays flowcharts representing the asynchronous background processes 1600 that the present invention executes without direct user interaction in order to achieve more reliable and performant analysis results. Two related flowcharts are shown in this illustration. The first background process starts with step 1602 and examines the system for recently created or modified data to retrieve in step 1606. In step 1608 the process retrieves the goal settings and in step 1610 executes the goal agents described previously against the available data. The results are analyzed in step 1630. The results are then stored to the system database in step 1646; alternatively, if the results data contains enough information for recommending configuration changes in the building or components, the data can be used to automatically build and store the proposal in the system database in step 1628 as well as store the data results in the system database in step 1646.

Several other steps are possible from step 1606. These steps, 1612, 1614, 1616, 1618, and 1620, are described below.

An additional component of this process is to determine from the available results data and previously stored system data which additional information can be “inferred” in step 1612. This inference determines data which is previously known and can be related to existing data which has been entered in to the system from the sources described in FIG. 1. Examples of this include relating the energy characteristics of equipment based on the manufacturer and model, determining the default building shell characteristics based on local building codes, or determining energy system details or replacements based on data which is considered statistically relevant based on previous entries in the system. This information is then applied and related to the retrieved data in step 1632. These results are then stored in step 1646.

A further component of this process will analyze the existing formulas in use for the goal agents in step 1616; where applicable, the formulas are simplified and reduced using constant values from the retrieved data in step 1622. The resulting new formulas are then used to evaluate the data to verify the functional results in step 1642. The resulting derived formulas are then stored in the system for ongoing future use in step 1644.

An additional part of this process evaluates the new data in step 1618 and determines the statistical significance of this data in step 1624. Information that is deemed significant as described and exemplified above due to a statistical consistency in the values is gathered in step 1636 and used to create a new globally available equipment entry in step 1640 that can be later used as described in step 1612. This new globally available equipment is saved in the following step, 1646.

A further aspect of this process occurs in step 1620, Normalize Data. In this case, individual existing observable object data is placed is added to a standardized virtual building in which all of the additional equipment and the building values are using specific predefined values. This allows simulations to be executed in 1626 in which a single component is the only variable. This allows two similar components (such as HVAC equipment, boilers, meters) to be compared and analyzed to determine a relative difference between the two components and which can additionally be compared towards the defined goals. The results of these comparisons can be further refined and validated by examining previously analyzed system that used the components in step 1638. These results can be further analyzed as previously described in step 1630.

The final aspect of this process begins in step 1648 when the result data is retrieved and used to rank existing building results in step 1650. The buildings scenarios are compared towards goals to determine the relative weight and amount of the goal achieved. For those buildings with only a baseline and no scenarios, the existing information is analyzed to determine the relative rank of the building scenarios against the baseline. This allows individual scenarios to be identified which are most closely aligned with and which are furthest from the configured goals. In a similar manner, step 1652 compares the rankings across all buildings to determine the building in the portfolio of buildings available are the most closely able to be aligned with the goals and which are furthest from achieving the goals. These results can then be used to determine which buildings can most efficiently be modified to achieve the goals and which need the most work to achieve the goals. These ranking results are then stored in step 1654 and the process continues as new data enters the system.

The second main process starts at step 1604 and involves the handling of queued functionality. This functionality represents tasks which are scheduled to be performed at the system's convenience. The first set of such tasks are collaboration messages which have been enqueued for distribution. These are read in step 1656 and sent to the recipients in step 1658. The results of this process are then stored in step 1680 and the next message is read in step 1656. Similarly, execution of Analysis functions is handled using a queue which is read in step 1662. If the function is defined as not able to be executed remotely—that is, unable to be executed on a connected client computer or peer computer—or there are no remote machines available (step 1664), the function is executed in a sandbox in step 1666 and stored in step 1668. The next queued function is then read by returning to step 1662. Functions which can be remotely executed are packaged (that is, prepared for transmission over some known protocol with any data required for the execution of that function) in step 1670 and transmitted to the remote system in step 1674 where a remote device (in this case, another connected client system) receives the package in 1674 and executes the function in a local sandbox, step 1676. This process allows for a reduced processor and memory usage on the present invention by allowing it to dynamically partition remote client systems to act as an extension of the core system. The results of the calculation are returned by the client in step 1678 and the main system receives the results (step 1680) and stores them in step 1668. This remote functionality adds an additional value to the system by allowing functions that are not previously known to be included by reference in the queue or by transmission as a remote function call to a client or peer system which has the ability to execute the function and provide the results. Functions which exist exclusively on an external system and are being called as a remote function, the package consists of the creation of a message to be delivered to the remote function using an agree-to protocol such as SOAP or REST to communicate the information and retrieve the results. For functions being executed remotely to a system that does not contain the function but instead contains a sandbox environment capable of executing the function in some form, the actual source code or byte code for the function can be transferred to allow the peer to remotely perform the entire processing of the function.

A person skilled in the arts will recognize that each of these background processes can be implemented as a series of additional processes that are centrally controlled and organized by the system to ensure the most efficient use of processor and memory resources.

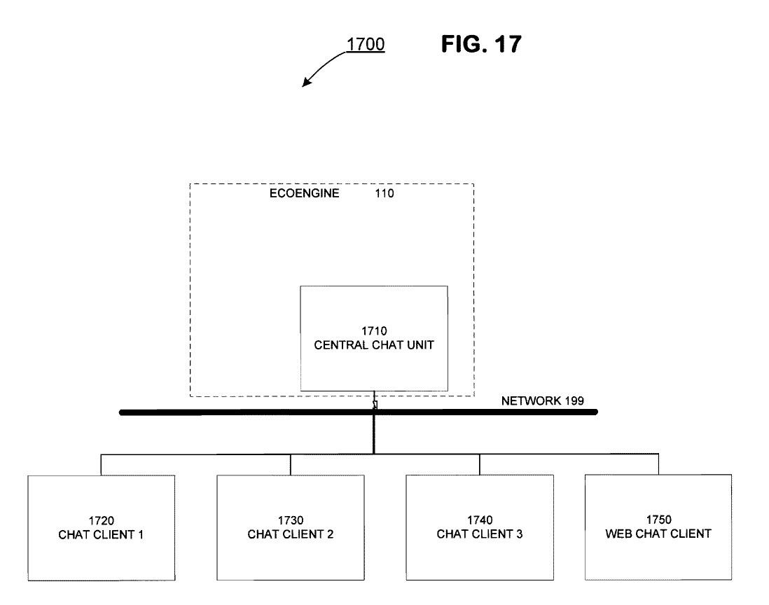

Continuing, in FIG. 17 you can see the overview of the software architecture for the collaborative chat functionality 1700 of the present invention. This functionality consists of a central chat unit 1710 in the ecoEngine 110 which can communicate with various instant messaging clients such as AOL IM, Yahoo Messenger, Live Chat, Microsoft Communicator, Microsoft Messenger, or Skype configured to run on separate client machines (exemplified as 1720, 1730, and 1740). In these cases, the client can remotely initiated by the present invention to allow team members to communicate with each other in real time. Methods of initiating such actions on a client are commonly known to those skilled in the art. Communications from each of the clients can be sent to the other clients despite the fact that each client might be using a different IM application. This can occur in either of several manners in the present invention. In the first manner, the system can attach a bot—an software component which listens for messages on that IM messages and can communicate responses to connected client—on the supported IM network to intercept calls from specific known accounts. The received messages from one network bot are then transmitted by the related bots installed on the other IM applications to connected clients on those networks. An alternative methodology can also be used in which the clients send a message to the server using a web based or rich client. The server can then use a component application capable of communicating with multiple instant messaging systems to automatically relay a copy of the message to the connected clients. In a final methodology, a plug-in can be installed in supported clients to interact with the previous methodology to allow the native IM client to transmit messages to other clients using the present invention. In this manner, distributed team members can use either their personal favorite IM tool or a system provided client to communicate in real time with other team members over a network 199.

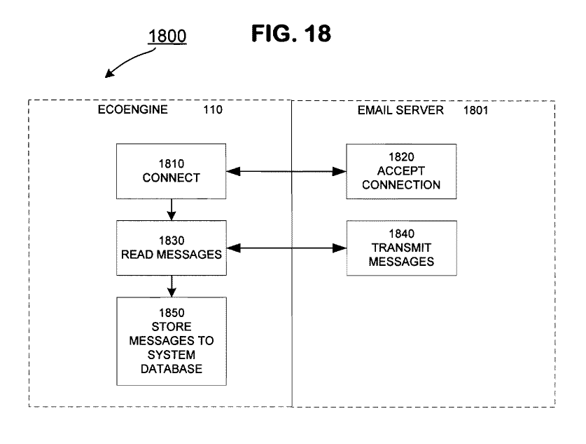

FIG. 18 illustrates an asynchronous collaboration process which provides email capabilities 1800 to the system for collaborative purposes. The ecoEngine 110 connects to the email server 1801 that is to be used by the team members in step 1810. The remote mail server 1801 accepts the connection in step 1820. The ecoEngine 110 then reads the messages in step 1830 from a specific account (as configured in the administrative collaboration settings, described above) on the email server 1801 which transmits said messages to the ecoEngine 110 for storage to the system database in step 1850. The messages are then available to the team members and to the administrator through the screens described above.

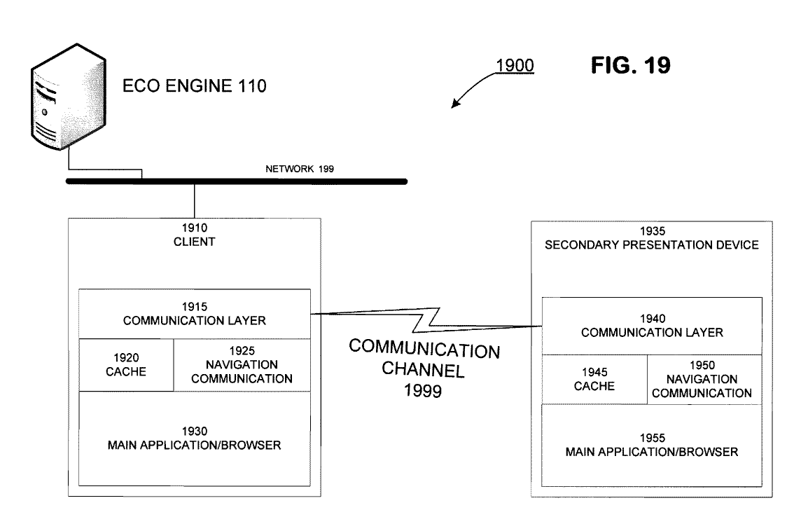

Next, FIG. 19 provides an overview 1900 of a connection from a remote device/client machine 1910 to the ecoEngine 110 over the network 199 to support a secondary client device. The client machine 1910 communicates from a local application/browser 1930 through the communication layer 1915 to interact with the system. In the preferred configuration of the invention, the client has a cache 1920 which allows some offline activity to be performed without a connection to the server and to improve performance. The secondary client 1935 is connected via a communication channel 1999 and contains a related communication layer 1940, cache 1945, and main application/browser 1955. Within the client 1910 is a navigation/communication component 1925 that tracks the navigation and related contents on behalf of the secondary presentation device 1935. This component relays the contents over the connection 1999 to the corresponding navigation communication component 1950 on the secondary presentation device 1935. In this manner, the secondary device 1935 can provide an alternative presentation of the data as well as allow navigation and viewing of the information from the ecoEngine 110. The communicated content sent/received on the connection 1999 does not have to match the content sent or received to the ecoEngine 110 and can thus be a second visualization of the same information. The present invention can use this arrangement to support viewing and visualizing alternative data presentations on the secondary device 1935 such as audio or Braille visualizations.

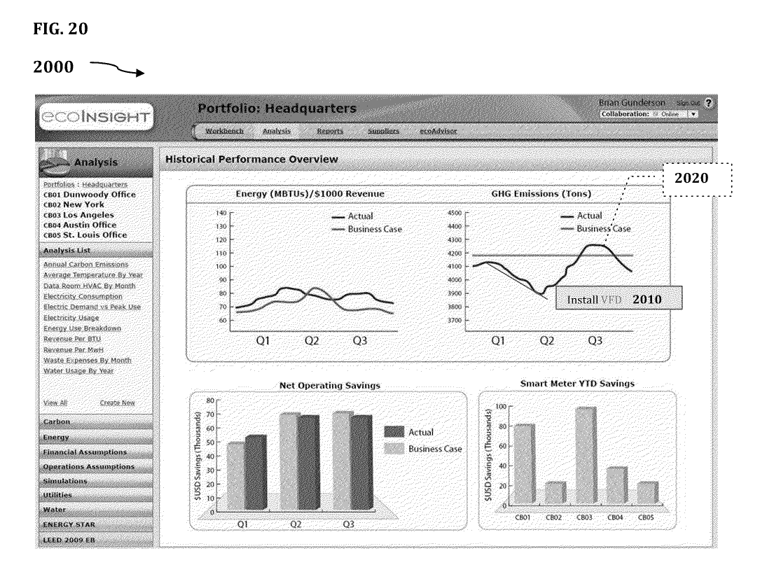

Finally, FIG. 20 provides an exemplary screen 2000 portraying method of displaying changes to energy systems that have occurred over time against data such as financial or consumption metrics to allow the cause-effect relationship of changes to be more easily visualized for analysis. A box containing the relative timing of a change 2010 can be displayed against a graph 2020 in order to more easily visualize this causal relationship. In the present invention, this display may be triggered as the mouse moves over the graphed information in the relative position of the change. In an alternative embodiment, it might be presented as a timeline below the graphed object.

What is claimed is:

1. A web-based auditing system, the system comprising:
a central management server configured to communicate through a wide area network, the central management server being configured to maintain a set of measured or calculated audit data for a plurality of buildings and facilities, with icons and text representing auditing and analysis tasks that may be performed in the process of auditing the structure and related energy-consuming equipment and shell characteristics; and
the first client device being configured to communicate with the central management server through the wide area network where the device includes a user interface for receiving user input and displaying user data, where the device is configured to receive a login request from the user and in response thereto, transmit a message containing the user specified and calculated information, including any related images.

2. The web-based auditing system of claim 1 where:
the first client device is further configured to display messages from the server with respect to tasks that must be performed during the course of the audit process and allowing the device to send a message communicating the status of this task in a task update message.

3. The web-based auditing system of claim 2, where the central management server is further configured verify the user is permitted to view and store data related to the audit tasks or a subset of the tasks.

4. The web-based auditing system of claim 3, where the central management server is further configured to capture detect common configurations of energy or resource consuming equipment to estimate the consumption of said equipment.

5. The web-based auditing system of claim 4, where the central management server is further configured to analyze the recorded information and to provide to the user recommendations for energy or resource consumption saving changes.

6. The web-based auditing system of claim 5, where:
the first client device is further configured to display the audited information and to detect selection of said information for criteria-based aggregation and to notify the central management server of the selection of this information, the information additionally being able to be configured with an alternative set of information representing changes which can modify the energy or resource consumption of the building or the audited equipment within the building, and the information being additionally configured with an optional set of information representing changes which might affect the comfort of occupants within that building or whom rely on that equipment, and the device is configured to display comparisons between the selected data and the alternative data related to energy or resource consumption changes and occupant comfort; and
the central management server is further configured to receive this request and in response store this information and transmit comparisons between the selected information and the alternative configuration.

7. The web-based audit system of claim 6, where:
the first client device is further configured to display instructional information advising the first user as to further manual or data capture actions to complete in the process; and
the central management server is further configured to receive this request and in response provide those further manual or data capture actions.

8. The web-based audit system of claim 5, where:
the first client device is further configured to display icons and instructional information for grouping the comparisons, selection information, alternative configuration and optional occupant comfort and grouping it into logical collections and transmitting this to the server, and the device is configured to display these grouped comparison of the aggregate energy or resource consumption derived from the individual selected information and alternative configurations and the calculated or user defined interactions between those elements which might further modify those comparisons, and the device is configured to allow the user to make changes to the individual and aggregated values, and the device is configured to verify the server has access to view the individual and aggregated comparisons and access to view or make changes to those comparisons; and
the central management server is further configured to receive this request an in response store this information and in response to transmit these aggregate comparisons including the comparisons of the selected information, alternative configurations, occupant comfort and any calculated interactions, and the central management server is further configured to verify the user has access to create or view the individual and aggregated values and comparisons and access to view or make changes to those comparisons.

9. The web-based audit system of claim 8, where:
the first client device is further configured to display and allow the printing of the aggregated and individual values as a report of those values; and
the central management server is further configured to receive this request and in response store the necessary information and in response to transmit that information in a printable electronic format or in a format from which the first client device can create a corresponding printable format representing the received information.

10. The method of claim 9, further comprising the steps of:
receiving the audited information from the first facility on the central management server.

11. The method of claim 10, further comprising the steps of:
compiling the audited information based on user defined criteria and storing the aggregated information;
calculating the most likely or most common values for the energy consumption or resource usage based on the audit information;
allowing the first user to change the collected and calculated values.

12. The method of claim 11, further comprising the steps of:
grouping the collection and calculated data into aggregations based on user criteria;
creating an alternative representation of that collection and comparing the resulting change in energy consumption, resource usage, or occupant perceived comfort; and
applying pricing and labor information to the collection relating to the change in cost, the cost of materials and labor, and/or maintenance costs.

13. The method of claim 12, further comprising the steps of:
overriding that information with values specified by the user.

14. The method of claim 13, further comprising the steps of:
grouping these comparisons together and analyzing the combined change in energy consumption, resource usage, or occupant comfort.

15. The method of claim 14, further comprising the steps of:
combining alternative financial assumptions and pricing information with the grouped comparisons to result in pricing and cost models, including NPV, IRR, and payback period;
saving and comparing components of the grouped comparisons using the financial and pricing assumptions;
saving and comparing the aggregated financial and pricing information in the collected group; and
saving and comparing aggregate pricing and labor information to the collection relating to the change in cost, the cost of materials and labor, and/or maintenance costs.

16. The method of claim 15, further comprising the steps of:
selecting grouped comparisons for reporting purposes; and
generating graphical and printed reports consisting of one or more of: the grouped comparisons, aggregations of the results, components of the selected groups, the financial assumptions, the combined financial impact of the aggregated group or its components, and/or a bill of materials for effectuating the proposed changes to the first building.

17. An interface unit for the entry and analysis of this of this information including one or more of a touch screen interface, pen based interface, keypad input device, or electronic data capture device.

18. The interface unit of step 17, wherein the electronic interface may include a browser interface.

19. The interface unit of step 18, wherein the electronic interface includes a graphical user interface.

20. The interface unit of step 17, wherein the electronic interface may include one or more of the following: video capture device, image capture device, audio capture device.

21. The interface unit of step 17, wherein the electronic interface may include one or more of the following: speech recognition, handwriting recognition.

22. A central management server configured to manage the work on a plurality of facilities from a plurality of users, the central management server comprising:
a database configured to store a plurality of facility and user records, a plurality of identifiers, a plurality of audited and calculated data, a plurality of the comparison data, a plurality of the aggregated comparison data;
a first application configured to receive from a first set of information including data capture related to a plurality of buildings and the equipment and characteristics of those buildings which consume or energy resources and the additional data necessary for making the comparisons, organizing the data, and grouping the data and collections of aggregated data;
a second application configured to aggregate, review, and correct the information in the first application;
a third application configured to receive a collection of the gathered data and related calculated values and organize that into groups with a replacement alternative for that group and the corresponding change in energy and resource consumptions, the related costs of materials and labor, and a corresponding bill of materials;
a fourth application configured to aggregate these collections and analyze them as an aggregation with varying financial assumptions;
a fifth application for generating reports based on the gathered data or aggregated collection data, the individual components, the related costs, or combinations thereof; and
a sixth application for perform complex analysis of the gathered or aggregated information to determine the energy consumption characteristics, costs over time, rated life, and the aggregate of those values as applied to the collections of comparisons, the components of those comparisons, and the aggregated of those comparisons.
